(19) United States
(12) Patent Application Publication
(10) Pub. No.: US 2009/0307719 A1
(43) Pub. Date: Dec. 10, 2009

(54) Configurable Access Lists for On-Demand Multimedia Program Identifiers

(75) Inventors: Jeff P. Clark, San Antonio, TX (US); David L. Dunmire, San Antonio, TX (US); Chad C. Keith, St. Louis, MO (US)

Correspondence Address: AT&T Legal Department - JW;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/134,085

(22) Filed: Jun. 5, 2008

(51) Int. Cl. H04N 7/10; H04N 7/173; H04N 5/445

(52) U.S. Cl. 725/32; 725/104; 725/87; 725/61

(57) ABSTRACT

Program identifiers from an electronic programming guide are added to a wish list. The wish list may be created automatically from user preferences or from manual user selections. In some embodiments, the wish list is available from different platforms including set-top boxes, personal computers, and mobile telephones. Users are not required to scroll through an entire list of available on-demand movie titles, for example, to choose those that may later be selected for viewing. Instead, a user may scroll through an entire list once and move any items of interest to a wish list for later consideration.

### BACKGROUND

1. Field of the Disclosure

The present disclosure generally relates to distribution of digital television content, and particularly, to managing wish lists that include program identifiers selected from electronic programming guides.

2. Description of the Related Art

Electronic programming guides may be presented to users to permit the users to select digital television content for viewing. For example, a user may scroll through a list of pay-per-view movies available for purchase.

### BRIEF DESCRIPTION OF THE DRAWINGS

FIG. 1 depicts a multimedia content distribution network enabled for distribution of digital television content and, in accordance with disclosed embodiments, for managing configurable access lists for on-demand multimedia program identifiers selected from electronic programming guides;

FIG. 2 depicts a graphical user interface that, in accordance with disclosed embodiments, includes a configurable access list for on-demand multimedia program identifiers with selectable program identifiers for songs, games and movies;

FIG. 3 depicts selected components of a remote control device operated by a user, in accordance with disclosed embodiments, to select program identifiers from an electronic programming guide for inclusion in a configurable access list; and

FIG. 4 depicts selected operations for setting up and managing a configurable access list for on-demand multimedia program identifiers (i.e., a wish list) in accordance with disclosed embodiments.

### DESCRIPTION OF THE EMBODIMENT(S)

In one aspect, a method of providing digital television content is disclosed. The method includes presenting a plurality of program identifiers that represent a corresponding plurality of multimedia programs that may be selected by user input. The multimedia programs may include on-demand movies, on-demand games, and on-demand digital television programs, as examples. The plurality of program identifiers may occur within e-mail advertisements, web banner advertisements, or as part of advertisements placed within then currently playing installments in a series of installments. The plurality of program identifiers may be presented on a smart phone. The method further includes receiving user input to tag a first portion of the program identifiers for addition to a wish list. The method may further include presenting an indication of the time for which a multimedia program will be available, if the multimedia program is scheduled to be unavailable for consumption after a period. The indication of the time for which the multimedia program will be available may be presented as a non-text based graphical indicator or as a text-based indicator. A user may be provided with user notification upon an unavailable multimedia program becoming available. Such user notification may occur by automatically sending e-mail notifications or short message service text message notifications.

In another aspect, an embodied digital television service includes presenting a user with a selectable program identifier that corresponds to an on-demand multimedia program. The selectable program identifier may be presented in an e-mail advertisement. The digital television service further includes providing the user a means of adding the program identifier to the user's wish list. The user's wish list may include previously added program identifiers corresponding to further on-demand multimedia programs. The digital television service further includes presenting the user with the wish list in response to user requests via the wish list. If the multimedia program is not yet available, the digital television service further includes presenting the user with a reminder regarding when the multimedia program is available. If the multimedia program is available for a limited time, the digital television service includes presenting the user with an indicator of the limited time. The digital television service may include providing the user with mobile access to the wish list from a smart phone.

Disclosed embodiments integrate a wish list with offerings of on-demand digital television content. While scrolling through an electronic programming guide (EPG) or when watching advertisements for future on-demand content, users are permitted to add on-demand selections (e.g., video on-demand, music on-demand, games on-demand, and the like) to a wish list. This allows a user that is searching an EPG, for example, for on-demand content to consume to group several programs, games, and the like for future consumption. Accordingly, disclosed embodiments help prevent users from having to “dig through” an entire library or EPG prior to each viewing session to select content. In addition, markers can be placed in advertising to allow for easy addition of currently available and upcoming content to a wish list directly from the advertisement.

Some disclosed embodiments permit tagging on-demand selections from an on-demand library presented by an EPG. Tagging on-demand selections may be through pressing a “tag” button on a remote button device, for example. In some cases, a user may press the “tag” button while an advertisement for the on-demand selection is playing. For example, if a user is viewing an email or is viewing a web site and an advertisement (e.g., a web banner advertisement) for a pay-per-view movie is presented, the user is allowed to tag the movie for addition to the wish list. In other embodiments, a user may tag content by selecting an icon that appears within a popover item over an on-demand item in an EPG. Some disclosed embodiments permit users to search and tag items remotely (e.g., via web access or a cellular telephone). In some embodiments, items that are either currently available or only available in the future may be added to the wish list through tagging. In addition, a tag may automatically apply to a plurality of programs, such as all episodes of a particular television show or all movies that contain a particular actor. In some cases, during a preview of “next week's episode” of a program, a user may tag the item for entry on the wish list. In some embodiments, predictive analysis may be performed to offer content to a user based on items in the wish list.

After a wish list is stored, a user may retrieve the wish list to choose a program from the wish list for consumption (e.g., viewing, listening, playing or the like). In a graphical user interface that displays the wish list, icons may be associated with items. In some cases, features of the icons may indicate an expiration date of the program associated with the icon. For example, if an on-demand movie on the wish list is only available for a short time, an icon may list an expiration date, may start to fade in appearance, may become red, or may provide some other indication that availability is limited. Similarly, icon changes may be used to indicate when “coming soon” content that has been added to the wish list becomes available. In addition, reminders of when wish list items become available may be sent via email, text message, cellular telephone call, or other suitable means. Embodied systems may also provide wish lists that include dependent or additional wish lists, such as having a child's wish list that is dependent on a parent's wish list. In this way, a parent may also set access controls (i.e., parental controls) for the child's wish list to permit access or deny access to certain content.

In the following description, details are set forth by way of example to enable one of ordinary skill in the art to practice the claimed subject matter without undue experimentation. It should be apparent to a person of ordinary skill that disclosed embodiments are examples and not exhaustive of all possible embodiments. Regarding reference numerals used to describe elements in the figures, a hyphenated form of a reference numeral refers to a specific instance of an element and the un-hyphenated form of the reference numeral refers to the element generically or collectively. Thus, for example, element “121-1” refers to an instance of an STB, which may be referred to collectively as STBs “121” and any one of which may be referred to generically as an STB “121.”

Before describing other details of embodied methods and devices, selected aspects of service provider networks that provide multimedia programs are described to provide further context.

Television programs, video on-demand (VOD) movies, digital television content, music programming, and a variety of other types of multimedia content may be distributed to multiple users (e.g., subscribers) over various types of networks. Suitable types of networks that may be configured to support the provisioning of multimedia content services by a service provider include, as examples, telephony-based networks, coaxial-based networks, satellite-based networks, and the like.

In some networks including, for example, traditional coaxial-based “cable” networks, whether analog or digital, a service provider distributes a mixed signal that includes a relatively large number of multimedia content channels (also referred to herein as “channels”), each occupying a different frequency band or channel, through a coaxial cable, a fiber-optic cable, or a combination of the two. The bandwidth required to transport simultaneously large numbers of multimedia channels may challenge cable-based providers. In these types of networks, a tuner within a set top box (STB), television, or other form of receiver is required to select a channel from the mixed signal for playing or recording. A user wishing to play or record multiple channels typically needs to have distinct tuners for each desired channel. This is an inherent limitation of cable networks and other mixed signal networks.

In contrast to mixed signal networks, internal protocol television (IPTV) networks generally distribute content to a user only in response to a user request so that, at any given time, the number of content channels being provided to a user is relatively small, e.g., one channel for each operating television plus possibly one or two channels for simultaneous recording. As suggested by the name, IPTV networks typically employ IP and other open, mature, and pervasive networking technologies. Instead of being associated with a particular frequency band, an IPTV television program, movie, or other form of multimedia content is a packet-based stream that corresponds to a particular network address, e.g., an IP address. In these networks, the concept of a channel is inherently distinct from the frequency channels native to mixed signal networks. Moreover, whereas a mixed signal network requires a hardware intensive tuner for every channel to be played, IPTV channels can be “tuned” simply by transmitting to a server an IP or analogous type of network address that is associated with the desired channel.

IPTV may be implemented, at least in part, over existing infrastructure including, for example, a proprietary network that may include existing telephone lines, possibly in combination with customer premise equipment (CPE) including, for example, a digital subscriber line (DSL) modem in communication with a STB, a display, and other appropriate equipment to receive multimedia content from a provider network and convert such content into usable form. In some implementations, a core portion of an IPTV network is implemented with fiber optic cables while the so-called “last mile” may include conventional, unshielded, twisted-pair, copper cables.

IPTV networks support bidirectional (i.e., two-way) communication between a subscriber's CPE and a service provider's equipment. Bidirectional communication allows a service provider to deploy advanced features, such as VOD, pay-per-view, advanced programming information (e.g., sophisticated and customizable EPGs), and the like. Bidirectional networks may also enable a service provider to collect information related to a user's preferences, whether for purposes of providing preference based features to the user, providing potentially valuable information to service providers, or providing potentially lucrative information to content providers and others.

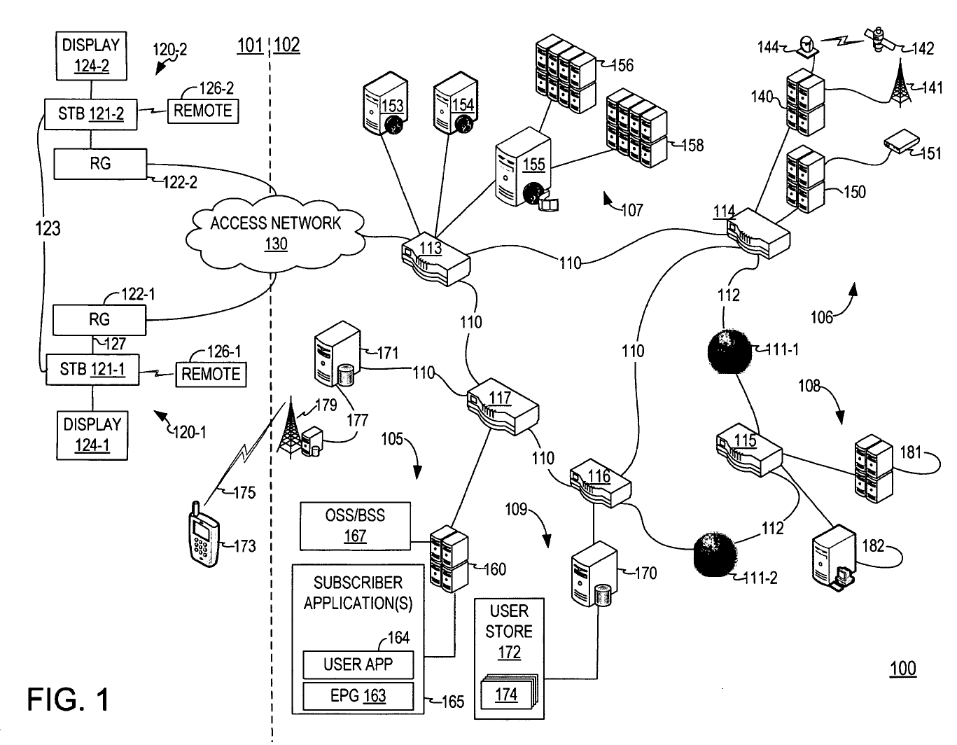

Referring now to the drawings, FIG. 1 illustrates selected aspects of a multimedia content distribution network (MCDN) 100 that may be enabled for a hand-held communications device such as a smart phone to manage delivery of digital television content to one or more STBs in accordance with disclosed embodiments. MCDN 100, as shown, is a provider network that may be generally divided into a client side 101 and a service provider side 102 (a.k.a. server side 102). The client side 101 includes all or most of the resources depicted to the left of access network 130 while the server side 102 encompasses the remainder.

Client side 101 and server side 102 are linked by access network 130. In embodiments of MCDN 100 that leverage telephony hardware and infrastructure, access network 130 may include the “local loop” or “last mile,” which refers to the physical wires that connect a subscriber's home or business to a local exchange. In these embodiments, the physical layer of access network 130 may include twisted pair copper cables or fiber optics cables employed as either fiber to the curb (FTTC) or fiber to the home (FTTH).

Access network 130 may include hardware and firmware to perform signal translation when access network 130 includes multiple types of physical media. For example, an access network that includes twisted-pair telephone lines to deliver multimedia content to consumers may utilize DSL. In embodiments of access network 130 that implement FTTC, a DSL access multiplexer (DSLAM) may be used within access network 130 to transfer signals containing multimedia content from optical fiber to copper wire for DSL delivery to consumers.

In other embodiments, access network 130 may transmit radio frequency (RF) signals over coaxial cables. In these embodiments, access network 130 may utilize quadrature amplitude modulation (QAM) equipment for downstream traffic. In these embodiments, access network 130 may receive upstream traffic from a consumer's location using quadrature phase shift keying (QPSK) modulated RF signals. In such embodiments, a cable modem termination system (CMTS) may be used to mediate between IP-based traffic on private network 110 and access network 130.

Services provided by the server side resources as shown in FIG. 1 may be distributed over a private network 110. In some embodiments, private network 110 is referred to as a “core network.” In at least some embodiments, private network 110 includes a fiber optic wide area network (WAN), referred to herein as the fiber backbone, and one or more video hub offices (VHOs). In large-scale implementations of MCDN 100, which may cover a geographic region comparable, for example, to the region served by telephony-based broadband services, private network 110 includes a hierarchy of VHOs.

A national VHO, for example, may deliver national content feeds to several regional VHOs, each of which may include its own acquisition resources to acquire local content, such as the local affiliate of a national network, and to inject local content such as advertising and public service announcements from local entities. The regional VHOs may then deliver the local and national content for reception by subscribers served by the regional VHO. The hierarchical arrangement of VHOs, in addition to facilitating localized or regionalized content provisioning, may conserve bandwidth by limiting the content that is transmitted over the core network and injecting regional content “downstream” from the core network.

Segments of private network 110, as shown in FIG. 1, are connected together with a plurality of network switching and routing devices referred to simply as switches 113 through 117. The depicted switches include client facing switch 113, acquisition switch 114, operations-systems-support/business-systems-support (OSS/BSS) switch 115, database switch 116, and an application switch 117. In addition to providing routing/switching functionality, switches 113 through 117 preferably include hardware or firmware firewalls, not depicted, that maintain the security and privacy of network 110. Other portions of MCDN 100 communicate over a public network 112, including, for example, the Internet or other type of web-network where the public network 112 is signified in FIG. 1 by the World Wide web icons 111.

As shown in FIG. 1, the client side 101 of MCDN 100 depicts two of a potentially large number of client side resources referred to herein simply as client(s) 120. Each client 120, as shown, includes an STB 121, a residential gateway (RG) 122, a display 124, and a remote control device 126. In the depicted embodiment, STB 121 communicates with server side devices through access network 130 via RG 122.

RG 122 may include elements of a broadband modem such as a DSL modem, as well as elements of a router and/or access point for an Ethernet or other suitable local area network (LAN) 123. In this embodiment, STB 121 is a uniquely addressable Ethernet compliant device. In some embodiments, display 124 may be any National Television System Committee (NTSC) and/or Phase Alternating Line (PAL) compliant display device. Both STB 121 and display 124 may include any form of conventional frequency tuner. Remote control device 126 communicates wirelessly with STB 121 using an infrared (IR) or RF signal.

In IPTV compliant implementations of MCDN 100, the clients 120 are operable to receive packet-based multimedia streams from access network 130 and process the streams for presentation on displays 124. In addition, clients 120 are network-aware systems that may facilitate bidirectional-networked communications with server side 102 resources to facilitate network hosted services and features. Because clients 120 are operable to process multimedia content streams while simultaneously supporting more traditional web-like communications, clients 120 may support or comply with a variety of different types of network protocols including streaming protocols such as reliable datagram protocol (RDP) over user datagram protocol/internet protocol (UDP/IP) as well as web protocols such as hypertext transport protocol (HTTP) over transport control protocol (TCP/IP).

The server side 102 of MCDN 100 as depicted in FIG. 1 emphasizes network capabilities including application resources 105, which may have access to database resources 109, content acquisition resources 106, content delivery resources 107, and OSS/BSS resources 108.

Before distributing multimedia content to users, MCDN 100 first obtains multimedia content from content providers. To that end, acquisition resources 106 encompass various systems and devices to acquire multimedia content, reformat it when necessary, and process it for delivery to subscribers over private network 110 and access network 130.

Acquisition resources 106 may include, for example, systems for capturing analog and/or digital content feeds, either directly from a content provider or from a content aggregation facility. Content feeds transmitted via VHF/UHF broadcast signals may be captured by an antenna 141 and delivered to live acquisition server 140. Similarly, live acquisition server 140 may capture down-linked signals transmitted by a satellite 142 and received by a parabolic dish 144. In addition, live acquisition server 140 may acquire programming feeds transmitted via high-speed fiber feeds or other suitable transmission means. Acquisition resources 106 may further include signal conditioning systems and content preparation systems for encoding content.

As depicted in FIG. 1, content acquisition resources 106 include a VOD acquisition server 150. VOD acquisition server 150 receives content from one or more VOD sources that may be external to the MCDN 100 including, as examples, discs represented by a DVD player 151, or transmitted feeds (not shown). VOD acquisition server 150 may temporarily store multimedia content for transmission to a VOD delivery server 158 in communication with client-facing switch 113.

After acquiring multimedia content, acquisition resources 106 may transmit acquired content over private network 110, for example, to one or more servers in content delivery resources 107. Prior to transmission, live acquisition server 140 may encode acquired content using, e.g., MPEG-2, H.263, a Windows Media Video (WMV) family codec, or another suitable video codec. Acquired content may be encoded and composed to preserve network bandwidth and network storage resources and, optionally, to provide encryption for securing the content. VOD content acquired by VOD acquisition server 150 may be in a compressed format prior to acquisition and further compression or formatting prior to transmission may be unnecessary and/or optional.

Content delivery resources 107 as shown in FIG. 1 are in communication with private network 110 via client facing switch 113. In the depicted implementation, content delivery resources 107 include a content delivery server 155 in communication with a live or real-time content server 156 and a VOD delivery server 158. For purposes of this disclosure, the use of the term “live” or “real-time” in connection with content server 156 is intended primarily to distinguish the applicable content from the content provided by VOD delivery server 158. The content provided by a VOD server is sometimes referred to as time-shifted content to emphasize the ability to obtain and view VOD content substantially without regard to the time of day or the day of week.

Content delivery server 155, in conjunction with live content server 156 and VOD delivery server 158, responds to user requests for content by providing the requested content to the user. The content delivery resources 107 are, in some embodiments, responsible for creating video streams that are suitable for transmission over private network 110 and/or access network 130. In some embodiments, creating video streams from the stored content generally includes generating data packets by encapsulating relatively small segments of the stored content in one or more packet headers according to the network communication protocol stack in use. These data packets are then transmitted across a network to a receiver (e.g., STB 121 of client 120), where the content is parsed from individual packets and re-assembled into multimedia content suitable for processing by a STB decoder.

User requests received by content delivery server 155 may include an indication of the content that is being requested. In some embodiments, this indication includes an IP address associated with the desired content. For example, a particular local broadcast television station may be associated with a particular channel and the feed for that channel may be associated with a particular IP address. When a subscriber wishes to view the station, the subscriber may interact with remote control device 126 to send a signal to STB 121 indicating a request for the particular channel. When STB 121 responds to the remote control signal, the STB 121 changes to the requested channel by transmitting a request that includes an IP address associated with the desired channel to content delivery server 155.

Content delivery server 155 may respond to a request by making a streaming video signal accessible to the user. Content delivery server 155 may employ unicast and broadcast techniques when making content available to a user. In the case of multicast, content delivery server 155 employs a multicast protocol to deliver a single originating stream to multiple clients. When a new user requests the content associated with a multicast stream, there may be latency associated with updating the multicast information to reflect the new user as a part of the multicast group. To avoid exposing this undesirable latency to the subscriber, content delivery server 155 may temporarily unicast a stream to the requesting subscriber. When the subscriber is ultimately enrolled in the multicast group, the unicast stream is terminated and the subscriber receives the multicast stream. Multicasting desirably reduces bandwidth consumption by reducing the number of streams that must be transmitted over the access network 130 to clients 120.

As illustrated in FIG. 1, a client-facing switch 113 provides a conduit between client side 101, including client 120, and server side 102. Client-facing switch 113, as shown, is so-named because it connects directly to the client 120 via access network 130 and it provides the network connectivity of IPTV services to users' locations.

To deliver multimedia content, client-facing switch 113 may employ any of various existing or future Internet protocols for providing reliable real-time streaming multimedia content. In addition to the TCP, UDP, and HTTP protocols referenced above, such protocols may use, in various combinations, other protocols including, real-time transport protocol (RTP), real-time control protocol (RTCP), file transfer protocol (FTP), and real-time streaming protocol (RTSP), as examples.

In some embodiments, client-facing switch 113 routes multimedia content encapsulated into IP packets over access network 130. For example, an MPEG-2 transport stream may be sent, in which the transport stream consists of a series of 188-byte transport packets, for example. Client-facing switch 113 as shown is coupled to a content delivery server 155, acquisition switch 114, applications switch 117, a client gateway 153, and a terminal server 154 that is operable to provide terminal devices with a connection point to the private network 110. Client gateway 153 may provide subscriber access to private network 110 and the resources coupled thereto.

In some embodiments, STB 121 may access MCDN 100 using information received from client gateway 153. Subscriber devices may access client gateway 153 and client gateway 153 may then allow such devices to access the private network 110 once the devices are authenticated or verified. Similarly, client gateway 153 may prevent unauthorized devices, such as hacker computers or stolen STBs, from accessing the private network 110. Accordingly, in some embodiments, when an STB 121 accesses MCDN 100, client gateway 153 verifies subscriber information by communicating with user store 172 via the private network 110. Client gateway 153 may verify billing information and subscriber status by communicating with an OSS/BSS gateway 167. OSS/BSS gateway 167 may transmit a query to the OSS/BSS server 181 via an OSS/BSS switch 115 that may be connected to a public network 112. Upon client gateway 153 confirming subscriber and/or billing information, client gateway 153 may allow STB 121 access to IPTV content, VOD content, and other services. If client gateway 153 cannot verify user information (i.e., subscriber information) for STB 121, for example, because it is connected to an unauthorized twisted pair or RG, client gateway 153 may block transmissions to and from STB 121 beyond the private access network 130.

MCDN 100, as depicted, includes application resources 105, which communicate with private network 110 via application switch 117. Application resources 105 as shown include an application server 160 operable to host or otherwise facilitate one or more subscriber applications 165 that may be made available to system subscribers. For example, subscriber applications 165 as shown include an EPG application 163. Subscriber applications 165 may include other applications as well. In addition to subscriber applications 165, application server 160 may host or provide a gateway to operation support systems and/or business support systems. In some embodiments, communication between application server 160 and the applications that it hosts and/or communication between application server 160 and client 120 may be via a conventional web based protocol stack such as HTTP over TCP/IP or HTTP over UDP/IP.

Application server 160 as shown also hosts an application referred to generically as user application 164. User application 164 represents an application that may deliver a value added feature to a subscriber. User application 164 is illustrated in FIG. 1 to emphasize the ability to extend the network's capabilities by implementing a network hosted application. Because the application resides on the network, it generally does not impose any significant requirements or imply any substantial modifications to the client 120 including the STB 121. In some instances, an STB 121 may require knowledge of a network address associated with user application 164, but STB 121 and the other components of client 120 are largely unaffected.

As shown in FIG. 1, a database switch 116 connected to applications switch 117 provides access to database resources 109. Database resources 109 include a database server 170 that manages a system storage resource 172, also referred to herein as user store 172. User store 172, as shown, includes one or more user profiles 174 where each user profile includes account information and may include preferences information that may be retrieved by applications executing on application server 160 including subscriber applications 165.

MCDN 100, as shown, includes an OSS/BSS resource 108 including an OSS/BSS switch 115. OSS/BSS switch 115 facilitates communication between OSS/BSS resources 108 via public network 112. The OSS/BSS switch 115 is coupled to an OSS/BSS server 181 that hosts operations support services including remote management via a management server 182. OSS/BSS resources 108 may include a monitor server (not depicted) that monitors network devices within or coupled to MCDN 100 via, for example, a simple network management protocol (SNMP).

As shown in FIG. 1, MCDN 100 provides an embodied digital television service that includes receiving a plurality of commands from communication device 173 over network 177. Communication device 173 may be a smart phone, personal digital assistant, or other currently available for future device that allows for managing content received by STBs 121. An embodied digital television service implemented using MCDN 100 includes providing digital television content to STB 121 in response to a plurality of commands entered into communication device 173. As shown, STB 121 is communicatively coupled through access network 130 to MCDN 100.

A user of communication device 173 may cause the issuance of a plurality of commands by a user agent running on communication device 173 over wireless communication channel 175. In some embodiments, the user agent is a software program or module that is stored on a computer readable media on communication device 173. The user agent may be enabled for web-based communication with access server 171 that, as shown, is communicatively coupled to the private network 110 to forward data indicative of the plurality of commands to content delivery server 155 within content delivery resources 107 (i.e., to an IPTV content server). In some embodiments, a communication session is established between communication device 173 and MCDN 100 through access server 171. As shown, a communication session may be established in part using cellular tower 179 which may be enabled for converting and conveying data indicative of a plurality of user commands over network 177 to access network 171. Establishing a session for communication between hand-held communication device 173 and the MCDN 100 may include a component of MCDN 100 (e.g., access server 171) receiving an incoming telephone call from communication device 173 through cellular tower 179. Alternatively, establishing the session may include placing an outgoing telephone call to communication device 173 from access server 171. In some embodiments, after establishing a session for communication between MCDN 100 and communication device 173, data corresponding to the digital television content may be sent over network 177 and wireless communication channel 175 to communication device 173. The data may originate from content delivery resources 107 or from STB(s) 121. In some embodiments, the data received by communication device 173 from MCDN 100 includes EPG data that may include program information regarding actors, ratings, program length, and the like. Data sent to communication device 173 may include streaming video content that represents or replicates that provided to or available to STB 121. In some embodiments, the streaming video content corresponds to a preview of a digital television program that is available to either or both of STBs 121. In this way, a user may employ his or her hand-held communication device (e.g., a smart phone) to preview content on another channel before the user changes to that “channel”.

As shown in FIG. 1, MCDN 100 may be used to provide a digital television service in accordance with disclosed embodiments. Accordingly, user selectable program identifiers may be presented on display 124. The user selectable program identifiers may be icons or selectable text, as examples that allow a user to select a program for immediate consumption or for addition to a wish list in accordance with disclosed embodiments. The user selectable program identifiers correspond to the on-demand multimedia programs such as VOD movies, pay-per-view sporting events, on-demand games, pay-per-view concerts, and the like. As examples, the selectable program identifiers that correspond to an on-demand multimedia program may be presented in email advertisements, in web banners, at the end of installments in a series of multimedia programs, or in other suitable ways for providing the user with potential program identifiers that may be added to a wish list.

MCDN 100 may also be used for providing a means of adding the program identifiers to the user's wish list. For example, a user may move a pointer on display 124 using a mouse, voice commands, a joystick, biometric sensors, eye movement sensors, a remote control with directional arrows, a touch screen, or similar input means for adding program identifiers to a user's wish list. Icons representing the program identifiers may be “clicked and dragged” to a wish list or otherwise selected. A user's wish list may include previously added program identifiers corresponding to other on-demand multimedia programs. In this way, the user is permitted to gather multimedia programs that he or she wishes to view or consider viewing later without having to “dig through” every available program identifier that may be presented by an EPG.

In response to user input to view the wish list, embodied digital television services provided by MCDN 100 may present the wish list on display 124. STB 121 may include computer program instructions stored on a computer readable media and enabled for presenting the wish list as part of an EPG, for example, on display 124. If any multimedia program on the wish list is not yet available for consumption, STB 121 or a network based server within MCDN 100 may be enabled for automatically sending the user a reminder regarding when the multimedia program is available. For example, a reminder may be sent from MCDN 100 to communication device 173, which may be a smart phone. If the multimedia program on the wish list is available only for limited time, a user may be presented by disclosed embodiments with one or more indicators conveying to the user how much time is available for viewing the multimedia program. For example, if a VOD movie on the user's wish list is only available for two more months, MCDN 100 may present to the user on communication device 173 or display 124 a date (i.e., a text-based indicator) to tell the user how much time the user has to view the movie. Alternatively, a graphical icon on display 124, communication device 173, or both may be presented to the user to indicate the time remaining for viewing a multimedia program. The graphical icon may change colors or may appear with varied transparency to indicate how much time is left to view the multimedia program.

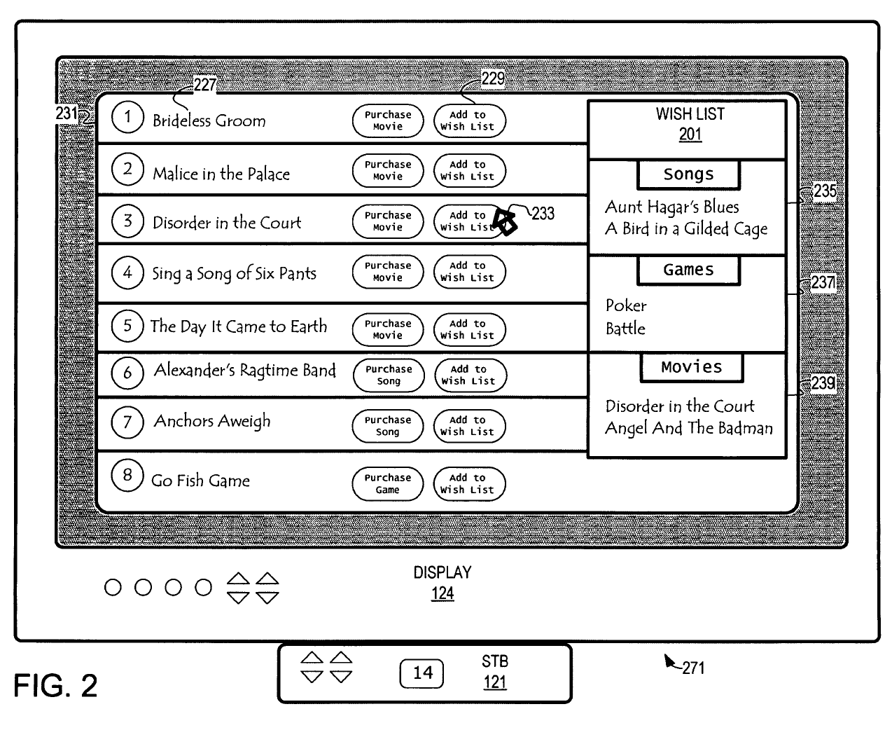

FIG. 2 illustrates display 124 with a graphical user interface 271 that includes EPG information including the names of multimedia programs available for viewing (i.e., for purchase) and for adding to wish list 201. As shown, entry 231 within graphical user interface 271 includes program identifier 227. Entry 231 corresponds to a movie entitled “Brideless Groom” that may be added to wish list 201 by moving cursor 233 over icon 229 and “clicking and dragging” icon 229 over subpart 239. As shown, subpart 239 includes program identifiers for a plurality of movies. Similarly, subpart 237 includes program identifiers for a corresponding plurality of games and subpart 235 includes a plurality of program identifiers for a corresponding plurality of songs.

Graphical user interface 271 and wish list 201, in disclosed embodiments, may be hosted and presented to display 124 by STB 121. STB may include computer instructions stored on computer readable media that enable STB 121 to present on display 124 the graphical user interface 271 including wish list 201. Alternatively, STB 121 may be enabled for downloading or accessing pages from a public or proprietary network (e.g., MCDN 100) for presenting graphical user interface 271 including wish list 201.

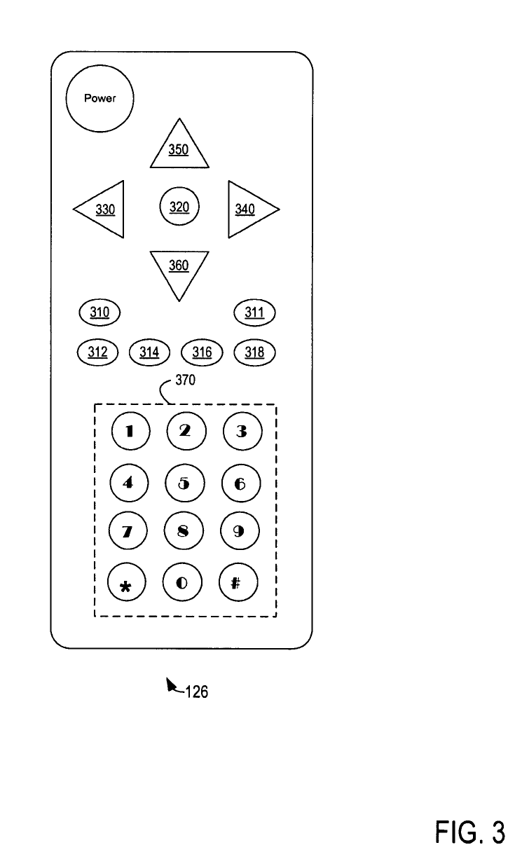

FIG. 3 illustrates an example remote control 126 suitable for use with STB 121 from FIG. 1 and FIG. 2, for providing a user with a means for selecting program identifiers for addition to a wish list in accordance with disclosed embodiments. The buttons and functionality of remote control 126 are described to illustrate basic functionality and are not intended to limit other possible functionality that may be incorporated into other embodiments. For example, although not shown, the buttons or indicators of remote control 126 may include a button, a knob, a touch screen, voice recognition capabilities, biometric sensors, eye-movement detection sensors, or a wheel for receiving input.

In the embodiment depicted in FIG. 3, remote control 126 has various function buttons 310, 311, 312, 314, 316, and 318, a “select” button 320, a “backward” or left-ward button 330, a “forward” or right-ward button 340, an “upward” button 350, and a “downward” button 360. The number, shape, and positioning of buttons 310 through 360 is an implementation detail and other embodiments may employ more or fewer buttons of the same or different shapes arranged in a similar or dissimilar pattern. In disclosed embodiments to select a program identifier for addition to a wish list, buttons 340, 330, 360 and 350 may be used to position an on-screen pointer over an icon and select button 320 may be used to receive user input. For example, in FIG. 2, within the graphical user interface 271 on display 124 in FIG. 2, pointer 233 may be maneuvered by a user depressing buttons 340, 330, 360 and 350 and, once the pointer 233 is over the appropriate icon in the graphical user interface (e.g., an “add to wish list” icon for a program entry within an EPG) the user may depress “select” button 320 to select the program for addition to the wish list. Button 320 may additionally be considered an “Enter” button or an “OK” button. Keypad 370 as shown is a numeric keypad that permits a user an option of selecting channels by entering numbers as is well known. In other embodiments, keypad 370 may be an alphanumeric keypad including a full or partially full set of alphabetic keys.

In an example embodiment, function buttons 310, 311, 312, 314, 316, and 318 may be configured and enabled for managing a wish list in accordance with disclosed embodiments. For example, function button 310 may be configured as an “add to wish list” button to permit a user to add a selected program to the user's wish list. Similarly, function button 311 may be configured as a “display wish list button” to prompt a disclosed system to present the user's wish list on a display. Function button 312 may be configured as a “display programs on the wish list about to expire” button, so that a list of all movies that are about to become available can be seen. Function buttons 314, 316, and 318 may, for example, be configured to manage wish lists for secondary users. For example, a parent (i.e., a primary user) may configure function buttons 314, 316, and 318 to permit the parent easy access to the wish lists of the parent's children. To this end, remote control 126 may be used to provide permission level input from a primary user regarding a secondary user's wish list.

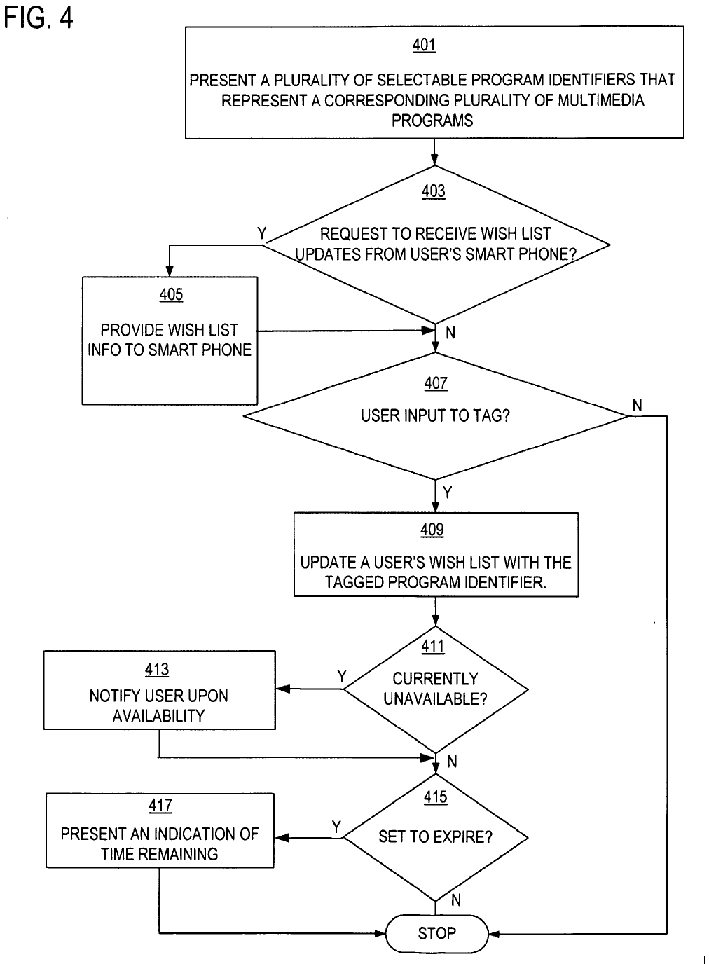

Referring now to FIG. 4, selected operations of a methodology are illustrated for providing digital television content and permitting users to maintain one or more wish lists in accordance with disclosed embodiments. As shown, operation 401 relates to presenting a plurality of program identifiers that represent a corresponding plurality of multimedia programs. The plurality of program identifiers are selectable in that they may be selected by user input. In optional operation 403, if a request to receive wish list updates from a user's smart phone is received, a wish list may be provided to the user's smart phone in operation 405. Disclosed systems then monitor for user input indicating that a user would like to add one or more program identifiers to the user's wish list. In operation 407, if a user input to tag a multimedia program is received, then in operation 409 the user's wish list is updated with the tagged program identifier. For example, as shown in FIG. 2, a user may tag, by selecting icon 229, the movie entitled Brideless Groom associated with program identifier 227. Operation 411 relates to determining whether movies or other programs on the user's wish list are currently available. If the programs are currently unavailable, the disclosed method in operation 413 notifies the user regarding the availability of the program. For example, a user may receive a short messaging service (SMS) text message or email indicating a movie, pay-per-view sporting event, or other program on the user's wish list is available. As shown, operation 415 relates to determining whether items on the user's wish list are set to expire. For example, if a movie is only available for two more weeks for download or viewing, disclosed methods may notify the user in operation 417 regarding the time left for downloading or viewing. In this way, disclosed methodologies provide a user the ability to manage wish lists for content the user may want to view, record or otherwise consume later. Notifications to cellular telephones, smart phones, personal digital assistants, pagers, computers, and the like may be sent to a user to help the user know when items on the wish list are set to expire or become available.

While the disclosed systems may be described in connection with one or more embodiments, it is not intended to limit the subject matter of the claims to the particular forms set forth. On the contrary, disclosed systems are intended to include alternatives, modifications and equivalents as may be included within the spirit and scope of the subject matter as defined by the appended claims. For example, the term “set-top box” or “STB” may be used to describe functionality that may be integrated into a television, residential gateway, or other receiver.

What is claimed is:

1. A method of providing digital television content, the method comprising:
presenting a plurality of selectable program identifiers that represent a corresponding plurality of multimedia programs; and
receiving a user input to select a first portion of the plurality of program identifiers for addition to a configurable access list, wherein the configurable access list includes a plurality of previously tagged program identifiers for on-demand multimedia programs, wherein program identifiers on the configurable access list are selectable by further user input for play.

2. The method of claim 1, wherein the multimedia programs are pay-per-view movies.

3. The method of claim 1, wherein the plurality of program identifiers that represent a corresponding plurality of multimedia programs are presented on a smart phone.

4. The method of claim 1, wherein presenting the plurality of program identifiers that represent a corresponding plurality of multimedia programs includes presenting a portion of the plurality of program identifiers within one or more advertisements.

5. The method of claim 4, wherein the advertisements are included with email advertisements, and wherein the method further comprises:
in response to user input to tag a program identifier included within an email advertisement, updating the configurable access list with the tagged program identifier.

6. The method of claim 4, wherein the advertisements are included with web banner advertisements, wherein the method further comprises:
in response to user input to tag a program identifier included within a web banner advertisement, updating the configurable access list with the tagged program identifier.

7. The method of claim 4, wherein the advertisements are included within currently-playing multimedia programs from a plurality of television series, and wherein the method further comprises:
in response to user input to tag a currently playing multimedia program from a television series, updating a user's configurable access list with the tagged program identifier.

8. The method of claim 1, wherein a portion of the plurality of multimedia programs include on-demand movies.

9. The method of claim 8, wherein a further portion the plurality of multimedia programs include on-demand games.

10. The method of claim 9, wherein the plurality of multimedia programs include on-demand digital television programs.

11. The method of claim 8, wherein a portion of program identifiers on the configurable access list correspond to multimedia programs that are scheduled to be unavailable for consumption after corresponding time periods, the method further comprising:
presenting an indication of the time periods.

12. The method of claim 11, wherein presenting an indication of the time periods includes presenting a text-based indicator.

13. The method of claim 11, wherein presenting an indication of the time periods includes presenting a non-text based graphical indicator.

14. The method of claim 1, the method further comprising:
providing a set-top box access to a multimedia program corresponding to a program identifier on the configurable access list in response to further user input to select the multimedia program for play.

15. The method of claim 1, wherein a portion of the plurality of program identifiers correspond to currently unavailable multimedia programs, wherein receiving user input to tag a first portion of the program identifiers includes receiving user input to tag a program identifier for a currently unavailable multimedia program, wherein the method further comprises:
providing user notification upon the currently unavailable multimedia program becoming available.

16. The method of claim 15, wherein providing user notification upon the currently unavailable multimedia program becoming available includes automatically sending an email to a user.

17. The method of claim 16, wherein providing user notification upon the currently unavailable multimedia program becoming available includes automatically sending a short message service text message to a user.

18. A digital television service comprising:
presenting a user with a selectable program identifier that corresponds to an on-demand multimedia program;
providing the user a means of adding the program identifier to the user's wish list, wherein the user's wish list includes previously added program identifiers corresponding to further on-demand multimedia programs;
presenting the user with the wish list in response to a user request to view the wish list; and
if the on-demand multimedia program is not yet available for play, presenting the user with a reminder regarding when the on-demand multimedia program is available for play; and
if the on-demand multimedia program is available for play for a limited time, presenting the user with an indicator of the limited time.

19. The digital television service of claim 18, wherein the selectable program identifier that corresponds to an on-demand multimedia program is presented in an email advertisement.

20. The digital television service of claim 18, wherein the selectable program identifier that corresponds to an on-demand multimedia program is presented in a web banner.

21. The digital television service of claim 18, wherein the digital television service further comprises:
providing the user mobile access to the wish list from a smart phone.

22. An application server enabled by a wish list application stored on computer readable media, the application server enabled for:
presenting a plurality of program identifiers that are selectable for addition to a wish list, wherein the plurality of program identifiers correspond to a plurality of on-demand multimedia programs;
receiving user input to add a portion of the plurality of program identifiers to the wish list;
determining whether individual multimedia programs of the plurality of on-demand multimedia programs are available for a limited time and, if so, presenting the user with an indication of the limited time; and
determining whether individual multimedia programs of the plurality of on-demand multimedia programs not yet available and, if so, presenting the user with an indication of availability at a predetermined period prior to availability.
